(19) United States
(12) Patent Application Publication
(10) Pub. No.: US 2023/0032426 A1
(43) Pub. Date: Feb. 2, 2023

(54) METHOD AND APPARATUS FOR GENERATING LEARNING DATA FOR NEURAL NETWORK

(71) Applicant: MARKANY INC., Seoul (KR)

(72) Inventors: Dong Geon Kim, Seoul (KR); Gyeong Gi Noh, Seoul (KR)

(21) Appl. No.: 17/488,303

(22) Filed: Sep. 29, 2021

(30) Foreign Application Priority Data
Jul. 30, 2021 (KR) 10-2021-0100346

(51) Int. Cl. G06K 9/00; G06K 9/32; G06K 9/40

(52) U.S. Cl. CPC G06K 9/00979; G06K 9/3258; G06K 9/40; G06K 9/00785; G06K 9/3275; G06K 2209/15

(57) ABSTRACT

A method for generating learning data for the neural network may comprise generating a license plate image by combining a background image, a frame image and a text image, generating a transformed image by performing at least one of a geometry transformation and a filter transformation on the license plate image, setting a text corresponding to the text image as target data for the transformed image, and generating the learning data including the transformed image and the target data.

### STATEMENT REGARDING GOVERNMENT SPONSORED RESEARCH

This work was supported by Seoul R&BD Program in Korea [CY201024, AI-based Smart City Safety Net Vehicle Search Service].

### CROSS-REFERENCE TO RELATED APPLICATIONS

This application claims priority to Korean Patent Application No. 10-2021-0100346 filed on Jul. 30, 2021, the disclosure of which is hereby incorporated by reference in its entirety.

### TECHNICAL FIELD

The present invention relates to a method and apparatus for generating learning data input to a neural network to train the neural network.

### BACKGROUND

In order to recognize a text from an image using the neural network, the neural network must learn, and a large amount of learning data is required to train the neural network. However, in the case of recognizing texts (numbers and letters) of a vehicle's license plate using the neural network, images (or photos) of the license plate are required as learning data, but there are many restrictions on collecting a large amount of these images. For example, as the climate and time zone change, illuminance and sharpness around the vehicle become also different; thus, there are restrictions on collecting the images of the license plate, and there are also restrictions on the legal aspects because the vehicle's number is personal information. In addition, since learning data collected at various points in time and in various environments is required for accurate training of the neural network, high time and human consumptions are taken to collect the images of the license plate.

### SUMMARY

### Problem to be Solved

The technical task to be achieved by the present invention is to provide a method and apparatus for generating learning data for a neural network. The technical task to be achieved in the present embodiments is not limited to the aforementioned technical task, and other technical tasks can be derived from the following embodiments.

### Means for Solving the Problem

As technical means for achieving the aforementioned technical task, a method for generating learning data for a neural network according to one embodiment may comprise generating a license plate image by combining a background image, a frame image and a text image; generating a transformed image by performing at least one of a geometry transformation and a filter transformation on the license plate image; setting a text corresponding to the text image as target data for the transformed image; and generating the learning data including the transformed image and the target data.

An apparatus for generating learning data for a neural network according to another embodiment may comprise a memory in which at least one program is stored; and a processor for executing said at least one program to generate learning data to train the neural network, wherein the processor generates a license plate image by combining a background image, a frame image and a text image, generates a transformed image by performing at least one of a geometry transformation and a filter transformation on the license plate image, sets a text corresponding to the text image as target data for the transformed image, and generates the learning data including the transformed image and the target data.

A storage medium according to one another embodiment may comprise a computer readable storage medium recording a program for executing the method according to one embodiment in a computer.

### Effect of the Invention

According to the present invention, the apparatus for generating learning data can effectively generate leaning data by generating, instead of collecting, a license plate image which is utilized for training a neural network, and transforming the generated license plate images in various manners.

The effect of the present invention is not limited to the aforementioned effect, and the effects which are not mentioned herein can be obviously understood from the present specification and the drawings attached herewith in view of a person having ordinary skill in the art to which the present invention pertains.

### BRIEF DESCRIPTION OF THE DRAWINGS

FIG. 1 is a diagram for explaining an example of a neural network architecture.

FIG. 2 is a diagram for explaining an operation performed in a neural network.

FIG. 3 is a diagram for explaining an example of the relationship between an input feature map and an output feature map in a neural network.

FIG. 4 is a block diagram illustrating an apparatus for generating learning data according to one embodiment.

FIG. 5 is a diagram illustrating license plate images according to various embodiments.

FIG. 6 is a diagram for explaining a method for generating a license plate image according to one embodiment.

FIG. 7 is a flowchart illustrating a method for generating a plurality of license plate images according to one embodiment.

FIGS. 8A-8C are diagrams illustrating geometry transformation of license plate images according to embodiments.

FIG. 9 is a diagram illustrating geometry-transformed images according to one embodiment.

FIG. 10 is a diagram illustrating filter transformation of a license plate image according to one embodiment.

FIG. 11 is a diagram illustrating various transformed images according to embodiments.

FIG. 12 is a diagram for explaining training of a neural network according to one embodiment.

FIG. 13 is a block diagram illustrating an electronic system according to one embodiment.

FIG. 14 is a flowchart illustrating a method for generating learning data according to one embodiment.

### DETAILED DESCRIPTION

Hereinafter, preferred embodiments of the present invention will be explained in detail with reference to the drawings attached herewith. The advantages and characteristics of the present invention, and the methods for achieving them would be clarified with reference to the embodiments to be explained below in detail, together with the drawings attached herewith. However, the present invention is not limited to the embodiments disclosed below and can be implemented in any other various manners, and these embodiments are provided just to complete the disclosure of the present invention and provide a person having ordinary skill in the art to which the present invention pertains with the scope of the invention completely, and the present invention is defined by the scope of the claims. The same reference numerals refer to the same elements throughout the entire specification.

Unless otherwise defined, all terms (including technical and scientific terms) used in the present specification can be used with the meaning that a person having ordinary skill in the technical field to which the present invention pertains can commonly understand. In addition, the terms defined in the generally used dictionary will not be ideally or excessively interpreted unless particularly defined.

The terms used in the present specification are just to explain the embodiments, and are not intended to limit the present invention. In the present specification, singular terms include plural terms unless particularly mentioned. The term “comprise” and/or “which comprise” used in the present specification do(es) not exclude the presence or addition of one or more elements other than the elements mentioned.

Unless otherwise mentioned in the present specification, the term “in contact with” or “connected” may include that one element/feature is directly in contact with or connected with other element/feature or that one element/feature is indirectly in contact with or connected by interposing other element/feature. Thus, various diagrams illustrated in the drawings illustrate exemplary arrangements of elements and components, but there may be additional mediation elements, devices, features or components (when assumed that the functions of the elements illustrated are not adversely affected) in the actual embodiments.

In addition, unless otherwise mentioned in the present specification, the expressions “first,” “second” and “third” are used just to distinguish the objects that the terms refer to for the explanation of the invention. In addition, even if the objects are referred to using “first,” “second,” etc., the contents of the objects they refer to may be the same depending on cases.

Hereinafter, embodiments of the present invention will be explained with reference to the drawings.

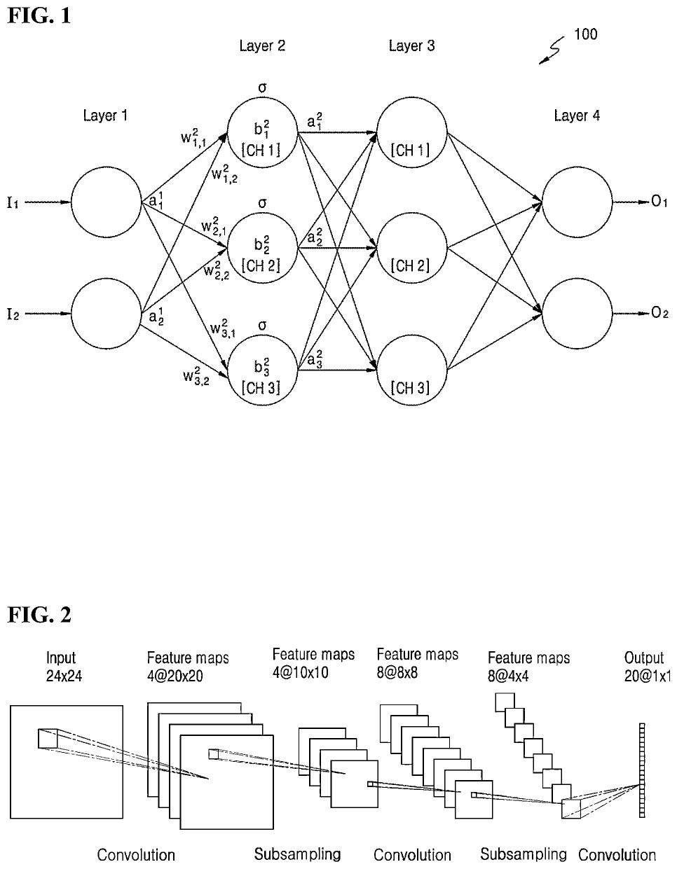

FIG. 1 is a diagram for explaining an example of a neural network architecture.

The neural network 100 illustrated in FIG. 1 may be an example of Deep Neural Network (hereinafter, referred to as “DNN”) or Deep Learning Network architecture. DNN may be Convolutional Neural Network (CNN), Recurrent Neural Network (RNN), Deep Belief Network, Restricted Boltzman Machine, Fully Connected Network, LSTM (Long short-term memory), Attention Mechanism Network, and the like, but is not limited thereto.

The neural network 100 may be a DNN including an input layer Layer1, two hidden layers Layer2 and Layer3, and an output layer Layer4. For example, when the neural network 100 represents Convolutional Neural Network (CNN), Layer 1 to Layer 4 may be part of the layers in the Convolutional Neural Network, and this may be a convolutional layer, a pooling layer, a fully connected layer, and the like.

Each of the layers included in the neural network 100 may comprise a plurality of artificial nodes, also known as “neurons”, “Processing elements (PEs)”, or “units.” For example, as shown in FIG. 1, Layer 1 may include two nodes, and Layer 2 may include three nodes. However, this is only an example, and each of the layers included in the neural network 100 may include various numbers of nodes.

The neural network 100 may perform an operation based on received input data (e.g., I₁ and I₂), and may generate output data (e.g., O₁ and O₂) based on the result of performing the operation.

The nodes included in each of the layers included in the neural network 100 may be connected to each other to exchange data. For example, one node may receive data from other channels and perform an operation, and may output the operation result to other nodes.

The input and output of each of the nodes may be referred to as input activation and output activation, respectively. That is, the activation may be an output of one channel and may also be a parameter corresponding to input of nodes included in a next layer.

Each of the nodes may determine its own activation based on activations that are received from nodes included in the previous layer, a weight, and a bias. The weight is a parameter used to calculate output activation in each node, and may be a value assigned to a connection relationship between nodes.

Each of the nodes may be processed by a computational unit or processing element that receives an input and outputs an output activation, and the input-output of each of the nodes may be mapped. For example, when σ is an activation function, wⱼₖⁱ is a weight from a k-th node included in (i−1)-th layer to a j-th node included in an i-th layer, bⱼⁱ is a bias of the j-th node included in the i-th layer, and aⱼⁱ is activation of the j-th node included in the i-th layer, activation aⱼⁱ may be calculated using Equation 1 as follows.

$${a}_{j}^{i} = σ ( {\sum }_{k} ( {w}_{jk}^{i} \times {a}_{k}^{i - 1} ) + {b}_{j}^{i} ) \qquad [ Equation 1 ]$$

As shown in FIG. 1, the activation of a first node, CH 1, of Layer 2 may be represented by a₁². In addition, a₁² may have a value of a₁²=σ(w_{1,1}²×a₁¹×w_{1,2}²×a₂¹+b₁²) according to Equation 1. However, Equation 1 described above is only an example for describing activation, weight, and bias used for processing data in the neural network 100, but is not limited thereto. The activation may be a value obtained by passing a weighted sum of activations received from the previous layer to an activation function such as a sigmoid function or a rectified linear unit (ReLU) function.

Meanwhile, when the neural network 100 is implemented in DNN architecture, the neural network 100 may include more layers capable of processing valid information. Thus, the neural network 100 may process data sets of higher complexity than a neural network having a single layer. FIG. 1 illustrates that the neural network 100 includes four layers, but this is only an example and the neural network 100 may include fewer or more layers. That is, the neural network 100 may include layers of various structures different from those shown in FIG. 1.

FIG. 2 is a diagram for explaining an operation performed at a neural network.

In the neural network, a convolution operation is performed between input data and a weight map, and as a result, feature maps are output. Weight maps are parameters for finding the features of input data, and they are also called kernel or filter. The generated output feature maps are convolution operated as input feature maps with a weight map, thereby outputting new feature maps. As a result of repeatedly performing this convolution operation, a result of operation of the input data through the neural network may be finally output.

For example, when data having a 24×24 size is input to the neural network of FIG. 2, the input data may be output as 4-channel feature maps having a 20×20 size through the convolution operation with the weight map. In addition, only some of the pixel values of the 4-channel feature maps having a 20×20 size are used through a sub-sampling process, thereby outputting 4-channel feature maps having a 10×10 size. As the sampling process, a max-pooling method, an average-pooling method, etc. may be applied.

After then, the 10×10 feature maps is reduced in size through repeated convolution operation and sub-sampling operation with the weight map, thus outputting global features in the end. The neural network may output feature maps from the input data by repeatedly performing the convolution operation and the sub-sampling (or pooling) in several layers, and finally obtain the operation result of the input data as the output feature maps are input to the fully connected layer.

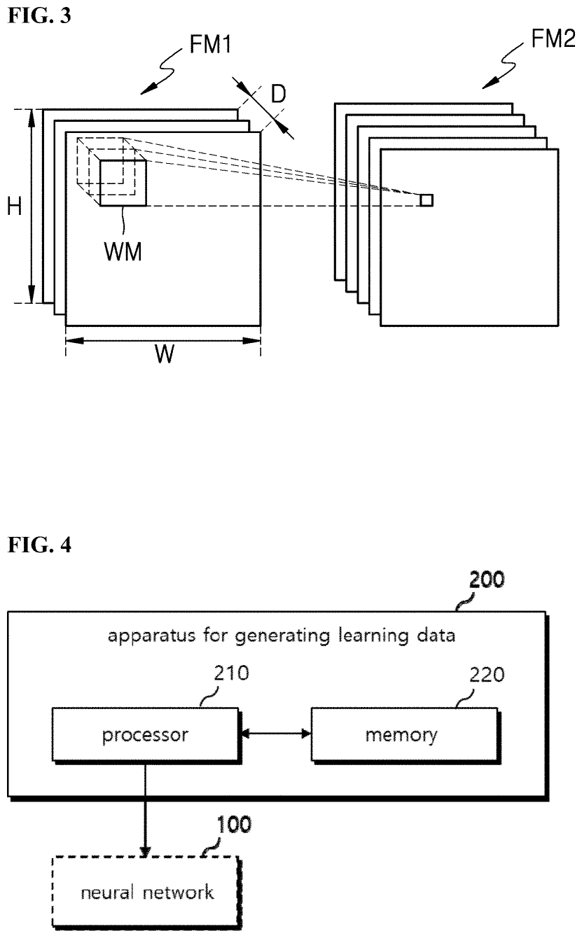

FIG. 3 is a diagram for explaining an example of the relationship between an input feature map and an output feature map in a neural network.

Referring to FIG. 3, in a layer in the neural network, a first feature map FM1 may correspond to an input feature map, and a second feature map FM2 may correspond to an output feature map. A feature map may refer to a set of data expressing various features of input data. The feature maps FM1 and FM2 may have elements of a two-dimensional matrix or elements of a three-dimensional matrix, and a pixel value may be defined in each element. The feature maps FM1 and FM2 have a width W (or referred to as a column), a height H (or referred to as row), and a depth D. The depth D may correspond to the number of channels.

A convolution operation may be performed on the first feature map FM1 and a weight map WM, and as a result, the second feature map FM2 may be generated. The weight map filters the features of the first feature map FM1 by performing a convolution operation with the first feature map FM1 by using a weight parameter defined in each element. The weight map performs a convolution operation with windows (or tiles) of the first feature map FM1 while shifting the first feature map FM1 by a stride in a sliding window manner. During each shift, each of the weight parameters included in the weight map may be multiplied with and added to each of the pixel values of an overlapped window in the first feature map FM1. As the first feature map FM1 and the weight map are convoluted, one channel of the second feature map FM2 may be generated. Although only one weight map is illustrated in FIG. 3, a plurality of weight maps may be respectively convoluted with the first feature map FM1 to generate a second feature map FM2 having a plurality of channels.

The second feature map FM2 may correspond to an input feature map of a next layer. For example, the second feature map FM2 may be an input feature map of a pooling (or sub-sampling) layer.

FIGS. 1 to 3 illustrate only a schematic architecture of the neural network for convenience of explanation. However, the neural network may be implemented with more or fewer layers, feature maps, weight maps, etc., unlike those illustrated, and the sizes thereof may also be variously modified.

FIG. 4 is a block diagram illustrating an apparatus for generating learning data according to one embodiment.

Referring to FIG. 4, the apparatus 200 for generating learning data may comprise a processor 210 and a memory 220. The apparatus 200 for generating learning data may input data to the neural network 100.

The apparatus 200 for generating learning data illustrated in FIG. 4 only shows components related to the present embodiments. Thus, it is obvious to a person having ordinary skill in the art that the apparatus 200 for generating learning data may further comprise any commonly used components, other than the components illustrated in FIG. 4.

For recognizing texts (numbers and letters) of a vehicle's license plate using the neural network 100, images (or photos) showing the license plate are required as learning data (or training data), but there are many restrictions on collecting a large amount of these images.

The apparatus 200 for generating learning data can effectively generate leaning data (or training data) by generating various license plate images by combining individual images stored in the memory 200, instead of collecting images of the actual vehicle's license plate, and transforming the generated images.

As the learning data generated at the apparatus 200 for generating learning data is used for training of the neural network 100, the text of a license plate can be more accurately recognized from an external image (or photo) obtained outside of the apparatus 200 for generating learning data. The external image is an image showing the license plate, and obtained (or photographed) outside of the apparatus 200 for generating learning data, and can be data input to the trained neural network 100 to recognize a text, not an image utilized for the generation of learning data.

Here, the vehicle can be any transportation means, without limitation, as long as a unique license plate is attached onto it. In addition, the license plate can be any number plate without limitation, as long as it is attached to a vehicle, regardless of whether it is attached to the front or rear of the vehicle.

The processor 210 may perform overall functions for controlling the apparatus 200 for generating learning data that comprises it. The processor 210 can overall control the apparatus 200 for generating learning data, by executing programs stored in the memory 220.

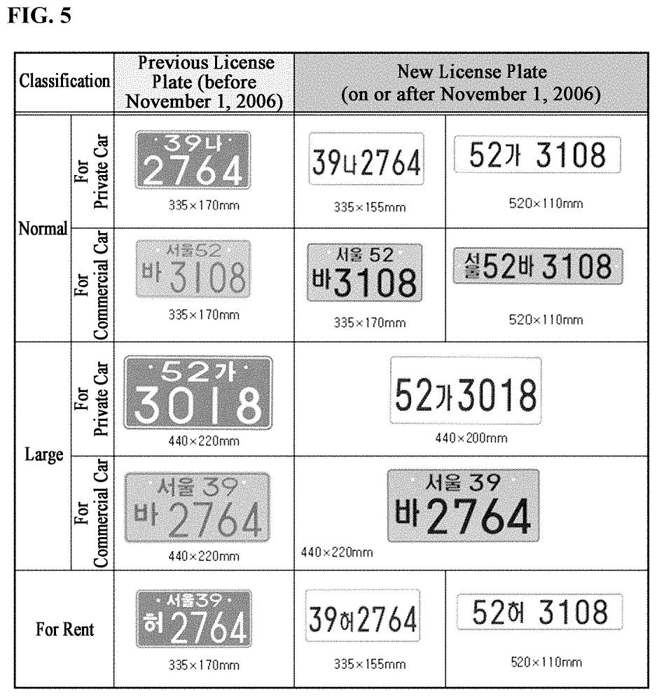

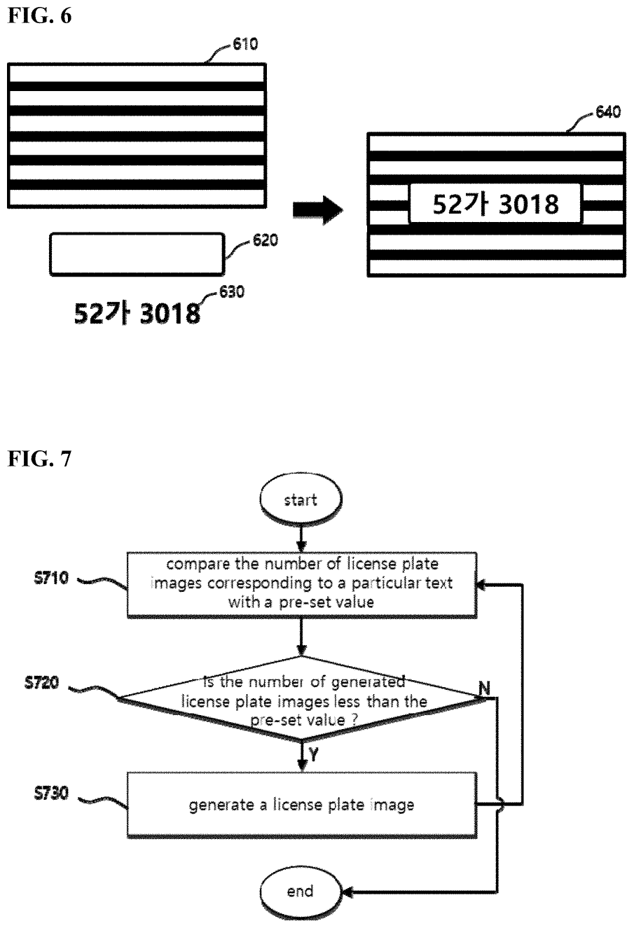

The processor 210 may generate a license plate image by combining individual images stored in the memory (220). The processor 210 may generate a license plate image by loading a background image, a frame image and a text image, which are the elements of the license plate image, from the memory 220 one by one, and combining the loaded images. The detailed method of generating the license plate image by combining the images will be described with reference to FIGS. 5 and 6.

The processor 210 may generate learning data in which the license plate image is variously transformed, such that even when external images obtained at various points in time and in various environments are input to the neural network 100, an accurate result can be generated from the neural network 100. For example, the processor 210 may perform at least one of geometry transformation and filter transformation on the license plate image. The order in which the processor 210 performs the geometry transformation and the filter transformation on the license plate image is not limited, but may be changed according to the setting.

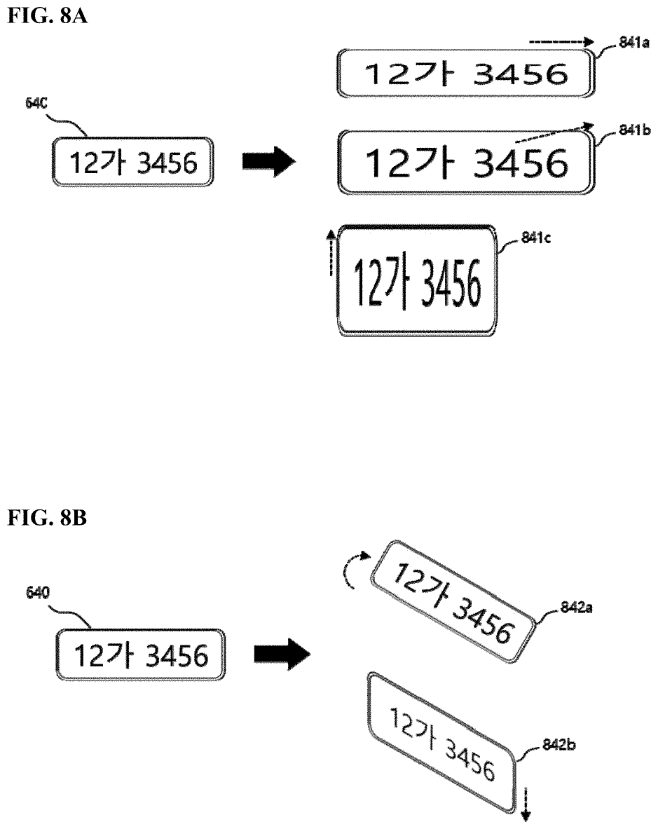

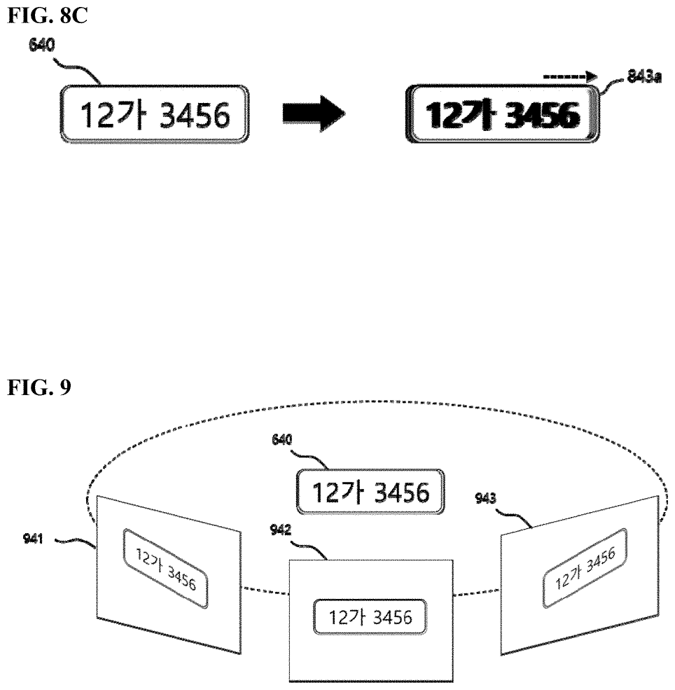

The processor 210 may generate a transformed image by performing geometry transformation on a generated license plate image. The geometry transformation may be a transformation method transforming all or some of the geometry structures of the license plate image. For example, the geometry transformation may include at least one of length transformation, tilt transformation, and motion blur transformation. The geometry transformation will be described below with reference to FIGS. 8 and 9.

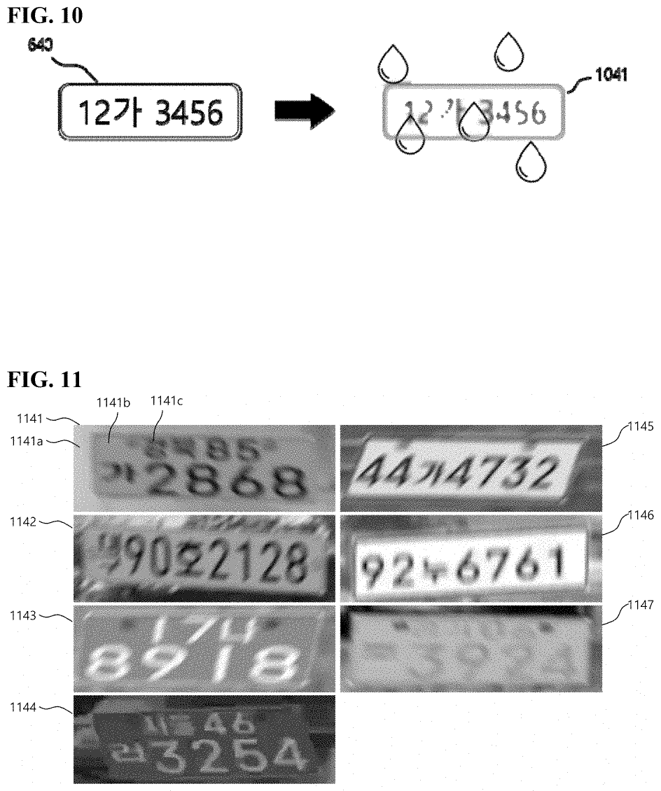

The processor 210 may generate a transformed image by performing filter transformation on a generated license plate image. The filter transformation may be a transformation method transforming the attributes of all or some of the license plate image. For example, the filter transformation may include at least one of sharpness transformation, brightness transformation, chroma transformation, contrast transformation, color transformation, noise transformation, transparency transformation, and climate application transformation. The filter transformation will be described below with reference to FIGS. 10 and 11.

Meanwhile, the processor 210 may perform a transformation on a license plate image such that the frame image and the text image correspond to each other in the license plate image. For example, the processor 210 may perform geometry transformation on the frame image and the text image by the same length or the same angle, or may perform filter transformation of transforming image attributes by the same value.

In addition, the processor 210 may perform a transformation only on the frame image and the text image while maintaining the background image in the license plate image, or may perform a transformation on all of the background image, the frame image and the text image, such that the background image, the frame image and the text image correspond to each other.

Further, the processor 210 may perform filter transformation on a geometry transformed image, or geometry transformation on a filter transformed image.

Also, the processor 210 may set a text corresponding to the text image as target data (or label data) corresponding to the transformed image. The target data is data included in the learning data, and the neural network 100 may be trained such that the target data (text) is output through a neural network operation on input data (transformed image) for the training of the neural network 100.

The text corresponding to a text image may correspond to a vehicle's number indicated in the license plate. The processor 210 may set the corresponding text as target data for a transformed image, such that when the transformed image is input to the neural network 100, the text corresponding to the transformed image (or text image include in the transformed image) is output from the neural network 100. In other words, the processor 210 may set target data and train the neural network 100, such that when an external image is input to the neural network 100, the text corresponding to the external image can be output from the neural network 100.

The processor 210 may generate learning data including transformed image and target data (text). The processor 210 may generate learning data by combining a transformed image that is subject to an operation with target data so as to generate data suitable to be input to the neural network 100.

The processor 210 may input learning data to the neural network 100 so as to train the neural network 100. The processor 210 may train the neural network 100, such that the target data (text) can be derived from a transformed image.

The processor 210 may be a processor 210 comprised in various kinds of computing devices such as PC (personal computer), a server device, a mobile device, an embedded device, an IoT (Internet of Things) device, etc. For example, the processor 210 may be a processor 210 such as CPU (central processing unit), GPU (graphics processing unit), AP (application processor), NPU (neural processing unit), but is not limited thereto.

The processor 210 may be implemented as an array of several logic gates, and may be implemented in combination with a commonly-used microprocessor and a memory 220 on which a program executable in this microprocessor is stored. In addition, a person having ordinary knowledge in the technical field to which the present embodiment pertains can understand that this can also be implemented as another form of hardware.

The memory 220 is hardware storing various kinds of data processed by a processor 210, which may store, for example, background images, frame images, text images and various kinds of filters, etc. In addition, the memory 220 may store various programs or applications, etc. to be driven by the processor 210.

The memory 220 may include at least one of a volatile memory and a nonvolatile memory. The nonvolatile memory includes ROM (Read Only Memory), PROM (Programmable ROM), EPROM (Electrically Programmable ROM), EEPROM (Electrically Erasable and Programmable ROM), flash memory, PRAM (Phase-change RAM), MRAM (Magnetic RAM), RRAM (Resistive RAM), FeRAM (Ferroelectric RAM), etc. The volatile memory includes DRAM (Dynamic RAM), SRAM (Static RAM), SDRAM (Synchronous DRAM), PRAM, MRAM (Magnetic RAM), RRAM (Resistive RAM), etc. In the embodiment, the memory 200 may be implemented by at least one of HDD (Hard Disk Drive), SSD (Solid State Drive), CF (compact flash), SD (secure digital), Micro-SD (micro secure digital), Mini-SD (mini secure digital), xD (extreme digital) and Memory Stick.

The neural network 100 may be comprised in a separate independent device implemented outside of the apparatus 200 for generating learning data. Here, the neural network 100 may receive an input of data by external apparatus 200 for generating learning data, and output the result of performing an operation. However, the neural network 100 may also be comprised in an apparatus 200 for generating learning data, unlike the one illustrated in FIG. 4. That is, the method of implementing the apparatus 200 for generating learning data and the neural network 100 is not limited to any one embodiment.

FIG. 5 is a diagram illustrating license plate images according to various embodiments.

From FIG. 5, it can be seen that various standards and various kinds of license plates are adopted depending on the size, use and release date, etc. of the vehicle. Thus, it would take much time and human effort to collect images for various kinds of license plates to generate learning data. The apparatus for generating learning data can generate learning data more economically and effectively by directly generating license plate images, instead of collecting images from outside.

FIG. 6 is a diagram for explaining a method for generating a license plate image according to one embodiment.

Referring to FIG. 6, a background image 610, a frame image 620 and a text image 630 are illustrated, and a license plate image 640 in which the background image 610, the frame image 620 and the text image 630 are combined is illustrated.

The background image 610 may correspond to an image corresponding to the front or rear of a vehicle on which the license plate is attached, or an image having other various patterns and colors. The shape and color of the front or rear are different for each vehicle, and even in the case of the same vehicle model, the shape around the license plate may be different because of tuning, etc. of the vehicle, and thus various background images are required. Additional examples of the background image 610 will be described with reference to FIG. 11.

The frame image 620 corresponds to a region where the text is excluded from the license plate, and may be formed with various standards, colors and shapes as illustrated in FIG. 5. In order to recognize license plates of various standards, the neural network 100 should be trained to learn accordingly, and thus frame images of various standards are required.

The text image 630 is an image including numbers and letters (i.e, a vehicle number) displayed on the license plate. The text image 630 may be formed in various font colors, font sizes, and arrangement of characters, as shown in the license plates according to FIG. 5. In order to recognize license plates of various standards, the neural network must be trained accordingly, and thus text images in various arrangements are required.

Meanwhile, the processor may generate a text image 630. The processor may generate a text image 630 for the text set based on information on a font, character arrangement, standard, etc., stored in the memory. As such, the processor may generate text images of various standards on the same text, or it may generate text images of the same standard on different texts. The processor may store the generated text images in the memory.

The memory may store a background image group, a frame image group, and a text image group. For generation of various license plate images, each image group may include various background images, various frame images, and various text images. To combine the frame image 620 and the text image 630, their respective standards (or versions) should correspond to each other, and thus, information on the standard of each image can also be stored in the memory. Thus, the frame image group and the text image group may include not only the images, but also information on their standards (or versions).

The processor may load an image from each of the background image group, the frame image group and the text image group. That is, the processor may load one background image 610 from the background image group stored in the memory, one frame image 620 from the frame image group, and one text image 630 from the text image group.

Meanwhile, since the standards of the frame image 620 and the text image 630 correspond to each other, the processor may load a frame image 620 and a text image 630 that correspond to each other in standard from the frame image group and the text image group based on the standard information of each image.

The processor may generate a license plate image 640 by combining loaded images. As illustrated in FIG. 6, the processor may combine a frame image 620 on the background image 610, and combine a text image 630 on the frame image 620.

The processor may generate various license plate images through various combinations. The license plate image 640 illustrated in FIG. 6 is just an example and can be variously modified and carried out.

FIG. 7 is a flowchart illustrating a method for generating a plurality of license plate images according to one embodiment.

Referring to FIG. 7, a method for generating a license plate image is composed of steps processed chronologically by the apparatus for generating learning data.

In Step S710, the processor may compare the number of the license plate images corresponding to the particular text with a pre-set value.

The pre-set value is the number of license plate images to be generated for one text. For example, when it is set to generate 1000 license plate images for text “52GA 3018”, the pre-set value corresponds to 1000, and the processor may compare the number of the license plate images corresponding to “52 GA 3018” with 1000.

In Step S720, the processor may determine whether the number of the license plate images is less than the pre-set value.

If the number of generated license plate images is less than the pre-set value, this means that the number of license plate images does not reach the target, so the processor may perform Step 730 in order to repeat the generation of license plate images. In Step S730, the processor may generate the license plate images by loading individual images and combining the loaded images. After then, the processor may perform Step S710 to compare again the number of the license plate images of a particular text with the pre-set value.

In Step S720, if it is determined that the number of generated license plate images is greater than or equal to than the pre-set value, this means that the number of the license plate images has reached the target, so the processor may finish the generation of license plate images. By such method, the processor can generate the pre-set number of the license plate images.

FIGS. 8a to 8c are diagrams illustrating geometry transformation of license plate images according to embodiments.

Referring to FIGS. 8a to 8c, the license plate image 640, and the images 841a˜841c, 842a˜842b, 843a obtained by performing the geometry transformation on the license plate image 640 are illustrated. For convenience of explanation, the background image of the license plate image 640 is omitted, and only the frame image and the text image are illustrated.

The geometry transformation may include at least one of length transformation, tilt transformation, and motion blur transformation. When performing the geometry transformation, the processor may perform one of length transformation, tilt transformation, and motion blur transformation, or perform a plurality of transformations on the license plate image 640. However, the aforementioned types of geometry transformation are just examples, and as long as it transforms the geometry structure of an image, the transformation can be included in the geometry transformation, without limitation.

In the embodiment according to FIG. 8a, the processor may perform length transformation on the license plate image 640. The processor may perform length transformation on the license plate image 640 by adjusting the length in one direction. Or, the processor may perform length transformation on the license plate image 640 by adjusting the length in a plurality of directions.

For example, the processor may generate a first length-transformed image 841a by expanding the length of the license plate image 640 in the right direction of FIG. 8a. Or, the processor may generate a second length-transformed image 841b by expanding the length of the license plate image 640 in the diagonal direction between the right side and the upper side of FIG. 8a. Or, the processor may generate a third length-transformed image 841c by expanding the length of the license plate image 640 in the upper direction of FIG. 8a. The length-transformed images 841a˜841c illustrated in FIG. 8a are just examples, and images expanded or reduced in various directions can be generated.

In the embodiment according to FIG. 8b, the processor may perform tilt transformation on the license plate image 640. The processor may perform tilt transformation on the license plate image 640 by rotating in one direction. Or, with one side of the frame of the license plate image 640 being fixed, the processor may perform tilt transformation by moving another side opposite said one side of the frame.

For example, the processor may generate a first tilt-transformed image 842a by adjusting the angle of the license plate image 640 in the clockwise direction of FIG. 8b. Or, the processor may generate a second tilt-transformed image 842b by moving the right line of the frame in the downward direction while fixing the left line of the frame of the license plate image 640. The tilt-transformed images 842a, 842b illustrated in FIG. 8b are just examples, and tilted (or rotated) images can be generated in various directions and methods.

In the embodiment according to FIG. 8c, the processor may perform motion blur transformation on the license plate image 640. Since there are many cases where obtained external images for a vehicle's license plate were shot while the vehicle was moving, the external image may display the license plate while the vehicle is moving not stationary. That is, traces of movement for a short time can be displayed in the external image. The processor can perform motion blur transformation to generate a transformed image in which the trace of moving is displayed such that also in this case, the accurate result can be output from the neural network.

The processor may perform motion blur transformation on a frame image by displaying the moving trace of the frame image while moving the frame image on the background image in one direction. In addition, the processor may perform motion blur transformation on a text image as well by displaying the moving trace of the text image while moving the text image on the frame image where the motion blur transformation was performed in the same direction as the direction of moving the frame image. That is, the processor may perform the motion blur transformation on the frame image and the text image such that the frame image and the text image correspond to each other on the background image. Or, the processor may perform the motion blur transformation on all of the license plate images including the background image.

In addition, the processor may gradually change brightness, sharpness or transparency between the moving start point and the moving end point for the moving trace of the image. For example, the processor may set the sharpness at the moving start point of the image to 50%, and set the sharpness of the moving end point of the image to 90%.

For example, the processor may perform motion blur transformation on the license plate image 640 in the right direction of FIG. 8c to generate a motion blur transformed image 843a. Referring to FIG. 8c, in the motion blur transformed image 843a, the moving trace from the moving start point of the license plate image 640 to the moving end point of the image is displayed. The motion blur transformed image 843a illustrated in FIG. 8c is just an example, and motion blur transformed images which are moved in various directions or in which various effects for the moving trace are applied can be generated.

FIG. 9 is a diagram illustrating geometry-transformed images according to one embodiment.

Referring to FIG. 9, a first geometry-transformed image 941, a second geometry-transformed image 942, and a third geometry-transformed image 943, which are generated by performing geometry transformation on the license plate image 640, are illustrated.

Since external images for the vehicle's license plate are obtained by photographing it at various angles, transformed images corresponding to the external images obtained at various angles are required. Thus, the processor may perform various types of geometry transformation on the license plate image 640 to generate various transformed images.

For example, the processor may generate a first geometry-transformed image 941 corresponding to the obtained external image photographed a certain angle at a left side from the front of the license plate image 640, or may generate a third geometry-transformed image 943 corresponding to the obtained external image photographed a certain angle at a right side, by performing tilt transformation and length transformation on the license plate image 640. In addition, the processor may generate a second geometry-transformed image 942 corresponding to the obtained external image photographed at the front of the license plate image 640 by performing length transformation on the license plate image 640, without performing tilt transformation.

Since the processor generates transformed images at various angles and these transformed images are utilized as learning data as illustrated in FIG. 9, the neural network may be trained to be capable of performing an accurate operation on external images as well that are obtained at various angles.

FIG. 10 is a diagram illustrating filter transformation of a license plate image according to one embodiment.

Referring to FIG. 10, a license plate image 640 and an image 1041 obtained by performing filter transformation on the license plate image 640 are illustrated. For convenience of explanation, in the license plate image 640, the background image is omitted, and only the frame image and the text image are illustrated.

The filter transformation may include at least one of sharpness transformation, brightness transformation, chroma transformation, contrast transformation, color transformation, noise transformation, transparency transformation and climate application transformation. However, the aforementioned types of the filter transformations are just examples, and any transformation that transforms the attributes of an image may be included in the filter transformation, without limitation. For example, the filter transformation may include blur transformation, granular transformation, film-effect transformation, sepia transformation or rain effect transformation, and the like.

When performing filter transformation, the processor may perform one of the filter transformations or perform a plurality of transformations on the license plate image 640.

The external images for the vehicle's license plate may be obtained in various environments such as various climates, various time zones, and various imaging systems, etc. That is, the same license plate may have different sharpness, color and noise of the license plate when displayed on external images. Also in this case, the processor may perform filter transformation to generate various transformed images such that accurate results can be output from the neural network 100. In the embodiment according to FIG. 10, the processor may perform sharpness transformation and climate effect transformation on the license plate image 640. The processor may perform sharpness transformation on the license plate image 640 by reducing sharpness, and perform climate effect transformation on the license plate image 640 by applying a rain filter. When the transformed image 1041 generated as such is utilized for training the neural network, the accuracy of the operation of the neural network on the external image obtained when raining can be improved. Meanwhile, the filter-transformed image 1041 illustrated in FIG. 10 is just an example, and transformed images on which various other filters are applied may be generated.

FIG. 11 is a diagram illustrating various transformed images according to embodiments.

Referring to FIG. 11, first to seventh transformed images 1141 to 1147 on which various geometry transformations and filter transformations were performed are illustrated. It can be seen that the background image 1141a, the frame image 1141b, and the text image 1141c are different in each of the transformed images.

It can be seen that tilt transformation was performed on the transformed images 1141 to 1146, except for the seventh transformed image 1147. In addition, it may be seen that motion blur transformation was performed on the transformed images 1141 to 1143 and 1145 to 1147, except for the fourth transformed image 1144. Also, it may be seen that sharpness transformation or the blur transformation is performed on the first to seventh transformed images 1141 to 1147. The first to seventh transformed images 1141 to 1147 may be ones on which various types of transformation other than the aforementioned types of transformations were performed.

As such, the processor may generate various transformed images by performing various types of transformation on various license plate images. As the neural network is trained by using these transformed images, accurate operation is possible even when various external images are input to the neural network.

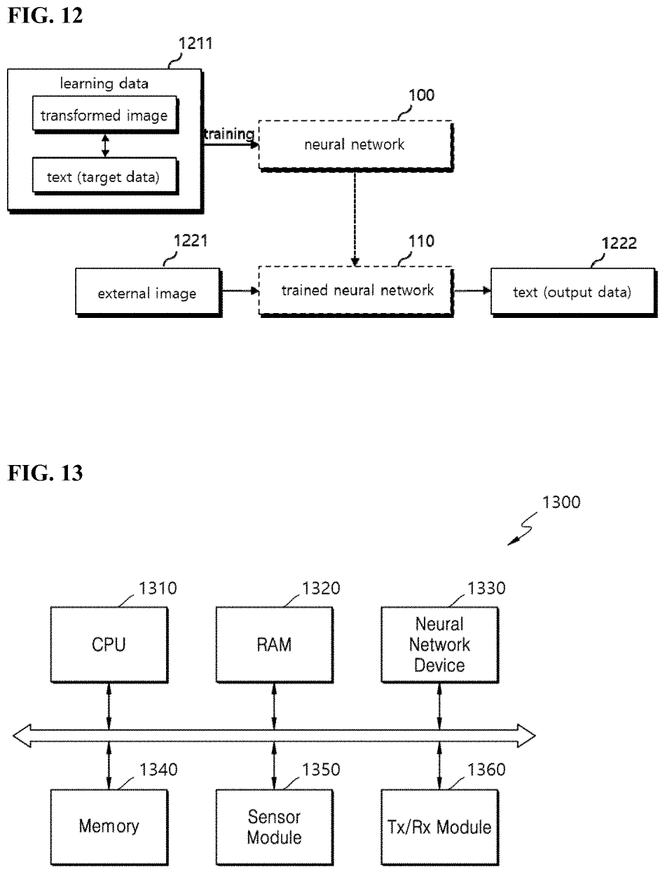

FIG. 12 is a diagram for explaining the training of the neural network according to one embodiment.

The apparatus for generating learning data may input learning data 1211 to the neural network 100, in addition to generating the learning data 1211 to train the neural network.

The processor may generate learning data 1211 including information on transformed images and texts by connecting a transformed image and the corresponding text (target data). For example, if the text image used in the license plate image displays the text “52GA 3018”, the text corresponding to the text image is “52GA 3018”, and the processor may set the text “52GA 3018” as the target data for the transformed image. Thus, in this case, the learning data 1211 may include the image transformed from the license plate image, and the text “52GA 3018” which is the target data.

The apparatus for generating learning data may input learning data 1211 to the neural network 100 to train the neural network. The apparatus for generating learning data may train the neural network 100 to output target data when the transformed image is input to the neural network 100. For example, the apparatus for generating learning data may train the neural network 100 such that a result to be output through operation of the neural network 100 on the transformed image becomes target data.

Specifically, the neural network 100 may be trained in such a way that various parameters of the neural network 100 are optimized, where the operation result of a transformed image and the target data is compared and the difference is reduced.

When an external image 1221 is input to the trained neural network 110 after the training of the neural network 100 is completed, a text 1222 corresponding to the external image 1221 may be output from the trained neural network 110. For example, when the external image 1221 in which “39GA 2764” is displayed on the license plate is input to the trained neural network 110, the text 1222 “39GA 2764” may be output.

FIG. 13 is a block diagram illustrating an electronic system according to one embodiment.

Referring to FIG. 13, the electronic system 1300 may extract valid information by analyzing input data in real time based on the neural network, and may make a determination on the on-going situation or control the configurations of an electronic device, on which the electronic system 1300 is mounted, based on the extracted information. For example, the electronic system 1300 may be applied to a computing device, a robot device, a smart TV, a smart phone, a medical device, a mobile device, an image display device, a measurement device, an Internet of Things (IoT) device, and the like, and may be mounted on at least one of various types of electronic devices.

The apparatus for generating learning data may include a CPU 1310, an RAM 1320, a memory 1340, a sensor module 1350, and a communication module 1360, and the neural network device 1330 may include a neural network. The electronic system 1300 may include the apparatus for generating learning data and the neural network device. The CPU 1310 of FIG. 13 may correspond to the processor of FIG. 4, and the RAM 1320 and the memory 1340 of FIG. 13 may correspond to the memory of FIG. 4. Thus, overlapping descriptions are omitted.

The apparatus for generating learning data may further include an input/output module, a security module, a power control device, and the like. Some of the hardware configurations of the electronic system 1300 may be mounted on at least one semiconductor chip. The neural network device 1330 may be a device including a hardware accelerator dedicated to the neural network.

The CPU 1310 controls the overall operation of the electronic system 1300. The CPU 1310 may include a single-core processor or a multi-core processor. The CPU 1310 may process or execute programs and/or data stored in the memory 1340. In one embodiment, the CPU 1310 may control the function of the neural network device 1330 by executing programs stored in the memory 1340.

The RAM 1320 may temporarily store programs, data, or instructions. For example, the programs and/or data stored in the memory 1340 may be temporarily stored in the RAM 1320 according to the control of the CPU 1310 or boot code. The RAM 1320 may be implemented as a memory such as DRAM or SRAM.

The neural network device 1330 may perform an operation of the neural network based on received input data and generate an information signal based on the result of the performing. The neural network device 1330 is hardware performing processing using the neural network, and may correspond to a hardware accelerator dedicated to a neural network.

The information signal may include one of various types of recognition signals such as a text recognition signal, an object recognition signal, and an image recognition signal. For example, the neural network device 1330 may receive an external image as input data and generate a text recognition signal corresponding to the external image. However, the present disclosure is not limited thereto, and the neural network device 1330 may receive various types of input data according to the type or function of an electronic device on which the electronic system 1300 is mounted, and may generate a recognition signal according to the input data.

The memory 1340 is where data is stored, and may store an operating system (OS), various programs, and various types of data. In an embodiment, the memory 1340 may store intermediate results, for example, an output feature map, generated during the operation of the neural network device 1330 in the form of an output feature list or output feature matrix. In an embodiment, a compressed output feature map may be stored in the memory 1340. Also, the memory 1340 may store quantized neural network data, such as parameters, weight maps, or weight lists, which are used in the neural network device 1330. The memory 1340 may include at least one of a volatile memory and a nonvolatile memory.

The sensor module 1350 may collect information around the electronic device on which the electronic system 1300 is mounted. The sensor module 1350 may sense or receive a signal (e.g., an image signal, a text signal, an audio signal, etc.) from the outside of the electronic device and convert the sensed or received signal into data. To this end, the sensor module 1350 may include at least one of various types of sensing devices such as a microphone, an imaging device, an image sensor, a light detection and ranging (LIDAR) sensor, an ultrasonic sensor, and an infrared sensor. The sensor module 1350 may provide the converted data as input data to the neural network device 1330. The sensor module 1350 may provide various types of data to the neural network device 1330.

The communication module 1360 may include various wired or wireless interfaces for communicating with an external device. For example, the communication module 1360 may include a communication interface connectable to a wired local area network (LAN), a wireless local area network (WLAN) such as wireless fidelity (Wi-Fi), a wireless personal area network (WPAN) such as Bluetooth, a wireless universal serial bus (USB), a zigbee, a near field communication (NFC), a radio-frequency identification (RFID), a power line communication (PLC), or a mobile cellular network such as 3rd generation (3G), 4th generation (4G), or long term evolution (LTE).

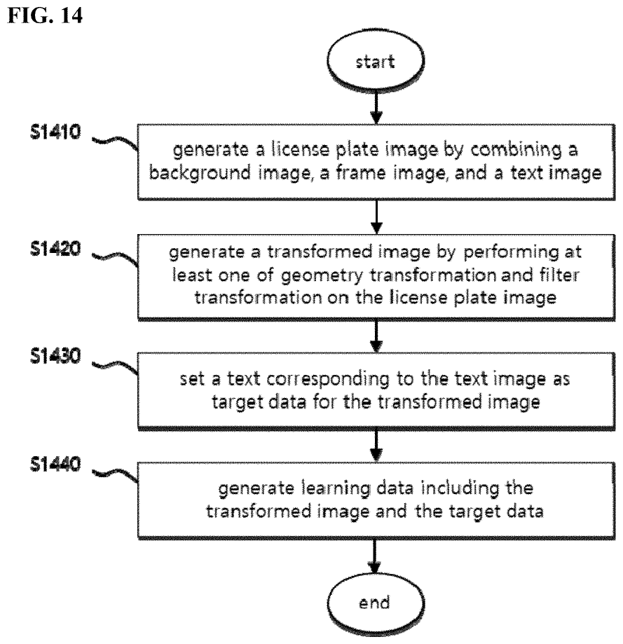

FIG. 14 is a flowchart illustrating a method for generating learning data according to one embodiment.

Referring to FIG. 14, the method for generating learning data is composed of steps processed chronologically by the apparatus for generating learning data illustrated in FIG. 4. Thus, it can be understood that the aforementioned content on the apparatus for generating learning data is also applied to the method of FIG. 14 even if it is not described below.

In Step S1410, the apparatus for generating learning data may generate a license plate image by combining a background image, a frame image, and a text image.

The apparatus for generating learning data may load one image from each of a background image group including a plurality of background images, a frame image group including a plurality of frame images, and a text image group including a plurality of text images.

The apparatus for generating learning data may load a frame images and text image that correspond to each other in standard from each of a frame image group including frame images having various standards and a text image group including text images having various standards. The apparatus for generating learning data may generate a license plate image by combining loaded images.

The apparatus for generating learning data may generate a plurality of license plate images by repeating the steps of generating a license plate image by loading image and combining the loaded images.

The apparatus for generating learning data may compare the number of generated license plate images that correspond to each text with a pre-set value. The apparatus for generating learning data may repeat the generation of license plate images when the number of license plate images corresponding respectively to texts is less than the pre-set value, and stop generating license plate images when the number is greater than or equal to the pre-set value.

In step S1420, the apparatus for generating learning data may generate a transformed image by performing at least one of geometry transformation and filter transformation on a license plate image.

The apparatus for generating learning data may perform geometry transformation on a license plate image such that the frame image and the text image correspond to each other in the license plate image.

The apparatus for generating learning data may perform geometry transformation only on the frame image and the text image while maintaining the background image in the license plate image. Or, the apparatus for generating learning data may perform geometry transformation on all of the background image, the frame image, and the text image.

The geometry transformation may include at least one of length transformation, tilt transformation, and motion blur transformation.

The apparatus for generating learning data may perform length transformation on a license plate image by adjusting the length in at least one direction.

The apparatus for generating learning data may perform motion blur transformation on a frame image by displaying the trace of the movement of the frame image while moving the frame image in the background image in one direction, and may perform motion blur transformation on the text image such that it corresponds to the frame image in the transformed frame image.

The filter transformation may include at least one of sharpness transformation, brightness transformation, chroma transformation, contrast transformation, color transformation, noise transformation, transparency transformation, and climate application transformation.

In Step S1430, the apparatus for generating learning data may set a text corresponding to the text image as target data for the transformed image.

In Step S1440, the apparatus for generating learning data may generate learning data including the transformed image and the target data.

After Step S1440, the apparatus for generating learning data may train the neural network such that the target data is output through an operation on the transformed image in the neural network.

Such operations performed by the apparatus for generating learning data may be performed in a computer-readable storage medium in which a program is recorded.

As non-limiting examples, computer-readable media may be used to store RAM, ROM, EEPROM, CD-ROM or other optical disk storage, magnetic disk storage or other magnetic storage devices, or desired program code means in the form of instructions or data structures, and may include any other storage medium that can be accessed by a general purpose or special-purpose computer or a general purpose or special-purpose processor. Discs and discs, when used herein, include compact discs (CDs), laser discs, optical discs, digital versatile discs (DVDs), floppy discs, and Blu-ray discs. Discs normally reproduce data magnetically, but discs optically reproduce data with a laser. Combinations of those aforementioned should also be included within the scope of computer-readable storage media.

The embodiments of the present invention have been explained with reference to the drawings attached herewith, and a person having ordinary skill in the art to which the present invention pertains may understand that the present invention can be carried out in any other specific forms, without changing the technical idea or essential features. Therefore, please note that the embodiments described above are just exemplary and are not limited thereto.

### DESCRIPTION OF REFERENCE NUMERALS

100: neural network
110: trained neural network
200: apparatus for generating learning data
210: processor
220: memory
610: background image
620: frame image
630: text image
640: license plate image
841a to 841c: first to third length-transformed images
842a, 842b: first and second tilt-transformed images
843a: motion blur-transformed image
941˜943: first to third geometry-transformed images
1041: filter-transformed image
1141˜1147: first to seventh transformed images
1141a: background image
1141b: frame image
1141c: text image
1211: learning data
1221: external image
1222: text (output data)
1300: electronic system
1310: CPU
1320: RAM
1330: neural network device
1340: memory
1350: sensor module
1360: communication module

1. A method for generating learning data for a neural network, comprising:
generating a license plate image by combining a background image, a frame image, and a text image;
generating a transformed image by performing at least one of geometry transformation and filter transformation on the license plate image;
setting a text corresponding to the text image as target data (label data) for the transformed image; and
generating the learning data including the transformed image and the target data.

2. The method for generating learning data for a neural network according to claim 1, wherein the generating a license plate image comprises:
loading one image from each of a background image group including a plurality of background images, a frame image group including a plurality of frame images, and a text image group including a plurality of text images; and
generating the license plate image by combining the loaded images, and
generating a plurality of the license plate images by repeating the steps of generating a license plate image by loading the image and combining the loaded images.

3. The method for generating learning data for a neural network according to claim 2, wherein the loading the image comprises loading a frame image and text image, which correspond to each other in standard, from each of the frame image group including frame images having various standards and the text image group including text images having various standards.

4. The method for generating learning data for a neural network according to claim 2, wherein the generating a plurality of the license plate images comprises
comparing the number of generated license plate images that correspond to each text with a pre-set value; and
repeating the generation of the license plate images when the number of the license plate images that correspond to each text is less than the pre-set value, and stopping generating the license plate image when the number is greater than or equal to the pre-set value.

5. The method for generating learning data for a neural network according to claim 1, wherein the generating a transformed image performs the geometry transformation on the license plate image such that the frame image and the text image correspond to each other in the license plate image.

6. The method for generating learning data for a neural network according to claim 1, wherein the generating a transformed image performs the geometry transformation only on the frame image and the text image while maintaining the background image in the license plate image.

7. The method for generating learning data for a neural network according to claim 1, wherein the geometry transformation includes at least one of length transformation, tilt transformation, and motion blur transformation.

8. The method for generating learning data for a neural network according to claim 7, wherein the generating a transformed image performs the length transformation on the license plate image by adjusting the length in at least one direction.

9. The method for generating learning data for a neural network according to claim 7, wherein the generating a transformed image comprises
performing the motion blur transformation on the frame image by displaying the trace of the movement of the frame image while moving the frame image on the background image in one direction; and
performing the motion blur transformation on the text image such that it corresponds to the frame image on the transformed frame image.

10. The method for generating learning data for a neural network according to claim 1, wherein the filter transformation includes at least one of sharpness transformation, brightness transformation, chroma transformation, contrast transformation, color transformation, noise transformation, transparency transformation, and climate application transformation

11. The method for generating learning data for a neural network according to claim 1, wherein the method for generating learning data for the neural network further comprises training the neural network such that the target data is output through an operation on the transformed image in the neural network.

12. An apparatus for generating learning data for a neural network, comprising:
a memory in which at least one program is stored; and
a processor for executing said at least one program to generate learning data for training the neural network,
wherein the processor generates a license plate image by combining a background image, a frame image, and a text image, generates a transformed image by performing at least one of geometry transformation and filter transformation on the license plate image, sets a text corresponding to the text image as target data for the transformed image, and generates the learning data including the transformed image and the target data.

13. A computer readable storage medium recording a program performing the method according to claim 1.
